(19) United States
(12) Patent Application Publication
(10) Pub. No.: US 2025/0212017 A1
(43) Pub. Date: Jun. 26, 2025

(54) BASE STATION SUPPORTING IN-BAND WIRELESS BACKHAUL

(71) Applicant: EUCAST CO., LTD., Seongnam-si (KR)

(72) Inventor: Dong Kwan LEE, Seongnam-si (KR)

(21) Appl. No.: 18/976,679

(22) Filed: Dec. 11, 2024

(30) Foreign Application Priority Data
Dec. 21, 2023 (KR) 10-2023-0188129
Mar. 28, 2024 (KR) 10-2024-0042599

(51) Int. Cl. H04W 16/32; H04W 36/34

(52) U.S. Cl. CPC H04W 16/32; H04W 36/34

(57) ABSTRACT

The present invention relates to a base station supporting a wireless backhaul operating on the same frequency band, and the wireless communication system providing communication services may include a wired backhaul and a type C base station that provides communication services to general terminals and backhaul terminals using the entire frame; a type A base station that forms a wireless backhaul using a first backhaul terminal and provides communication services to general terminals and backhaul terminals using only the first half-frame of the frame, and a type B base station that forms a wireless backhaul using a second backhaul terminal and provides communication services to general terminals and backhaul terminals using only the second half-frame of the frame.

### CROSS REFERENCE TO RELATED APPLICATION

The present application claims priority to Korean Patent Application Nos. 10-2023-0188129, filed Dec. 21, 2023 and 10-2024-0042599, filed Mar. 28, 2024, the entire contents of which is incorporated herein for all purposes by this reference.

### FIELD

The present invention relates to a base station, and more particularly, to a base station that supports in-band wireless backhaul.

### BACKGROUND

In mobile communication systems, wired technologies such as optical links are primarily used for base station backhaul. However, in environments where it is difficult or costly to install wired links, wireless backhaul can be considered.

While different communication technologies from the wireless access system can be used to support wireless backhaul in mobile communication environments, using the same system for both wireless access and wireless backhaul is a strong option when considering factors such as transmission speed and cost. Especially in 5th generation (5G) mobile systems, the active use of beamforming technology makes it even more advantageous to utilize wireless backhaul.

Given the limited frequency resources in mobile communication environments, being able to service both backhaul communication and multiple access terminals using a single frequency is highly beneficial. However, to perform both functions on a single frequency, it is essential to fully separate the two operations either in the frequency domain or the time domain to avoid interference between them.

### SUMMARY

The embodiments of the present invention aim to provide a base station that temporally separates backhaul communication and general access terminal service in a scenario where both operate on the same frequency band.

A wireless communication system providing communication services according to an embodiment may include a type C base station comprising a wired backhaul and configured to provide communication service to general terminal and backhaul terminal using entire frame, a type A base station configured to form a first wireless backhaul using a first backhaul terminal and provide communication service to general terminal and backhaul terminal using first half-frame of the frame and a type B base station configured to form a second wireless backhaul using a second backhaul terminal and provide communication service to general terminal and backhaul terminal using second half-frame of the frame.

The type A base station may form the first wireless backhaul through the first backhaul terminal connected to the type C base station or the type B base station, and the type B base station may form the second wireless backhaul through the second backhaul terminal connected to the type C base station or the type A base station.

The type A base station may transmit a wireless signal during the first half-frame of the frame to provide communication service, and the first backhaul terminal may transmit a wireless signal carrying backhaul data during the second half-frame of the frame, minimizing interference between the wireless signals.

The type B base station may transmit a wireless signal during the second half-frame of the frame to provide communication service, and the second backhaul terminal may transmit a wireless signal carrying backhaul data during the first half-frame of the frame, minimizing interference between the wireless signals.

The first backhaul terminal may be permitted to hand over to the type C base station or the type B base station, but not to the type A base station.

The second backhaul terminal may be permitted to hand over to the type C base station or the type A base station, but not to the type B base station.

The general terminal may be permitted to hand over to the type A base station, the type B base station, or the type C base station.

A base station system according to an embodiment may include a backhaul terminal and a base station, wherein the base station may be configured to set an operational type based on the availability of a wired backhaul connection, provide, based on a wired backhaul connection being available, wireless communication service using entire frame for data transmission and activate, based on a wired backhaul connection being unavailable, the backhaul terminal and provide wireless communication service using either the first half-frame or the second half-frame of the frame.

Further, the activated backhaul terminal may be configured to transmit backhaul data of the base station using the second half-frame or the first half-frame not in use by the base station for wireless communication service.

The base station is further configured to determine whether a wired backhaul connection is available, set, based on the wired backhaul connection being available, the base station as a type C base station providing wireless communication services using both the first half-frame and the second half-frame, and set, based on the wired backhaul connection being unavailable, the base station as a type B base station providing wireless communication service using the second half-frame upon the backhaul terminal connecting to an upper base station using the first half-frame or set the base station as a type A base station providing wireless communication service using the first half-frame based on the backhaul terminal connecting to the upper base station using the second half-frame.

Based on the base station being set as a type A base station, the backhaul terminal may be configured to perform handover only to the type B base station or the type C base station based on measurements of the second half-frame of the type B base station or the type C base station.

Based on the base station being set as a type B base station, the backhaul terminal is configured to perform handover only to the type A base station or the type C base station based on measurements of the first half-frame of the type A base station or the type C base station.

A method of operating a base station according to an embodiment may include determining whether a wired backhaul connection is available, setting and operating, based on a wired backhaul connection being available, as a type C base station providing wireless communication service using both first half-frame and second half-frame of a frame, activating, based on the wired backhaul connection being unavailable, a backhaul terminal, setting and operating, based on the backhaul terminal being connected to an upper base station using the first half-frame, as a type B base station providing wireless communication service using the second half-frame and setting and operating, based on the backhaul terminal being connected to the upper base station using the second half-frame, as a type A base station providing wireless communication services using the first half-frame.

The setting and operating as the type A base station may comprise providing wireless communication service to connected general terminals and backhaul terminals of other base stations using the first half-frame and transmitting backhaul data through the backhaul terminal during the second half-frame.

The setting and operating as the type B base station may comprise providing wireless communication service to connected general terminals and backhaul terminals of other base stations using the second half-frame and transmitting backhaul data through the backhaul terminal during the first half-frame.

The setting and operating as the type A base station may comprise allocating wireless resource for handover only during the first half-frame, and the setting and operating as the type B base station may comprise allocating wireless resource for handover only during the second half-frame.

### BRIEF DESCRIPTION OF THE DRAWINGS

FIG. 1 is a diagram illustrating a small cell system configuration utilizing wireless backhaul according to the present invention;

FIG. 2 is a diagram illustrating a frame structure used in type A base stations;

FIG. 3 is a diagram illustrating a frame structure used in type B base stations;

FIG. 4 is a diagram illustrating a frame structure used in type C base stations; and

FIG. 5 is a flowchart illustrating a method for determining the type of base station.

### DETAILED DESCRIPTION

Advantages and features of the present disclosure and methods of accomplishing the same may be understood more readily by reference to the detailed description of embodiments that will be made hereinafter with reference to the accompanying drawings. The present disclosure may, however, be embodied in many different forms and should not be construed as being limited to the exemplary embodiments set forth herein; rather, these exemplary embodiments are provided so that this disclosure will be thorough and complete and will fully convey the concept of the invention to those skilled in the art, and the present disclosure will only be defined by the appended claims. Throughout the specification, the same reference numerals refer to the same components.

When a component is described as “connected to” or “coupled to” another component, it can refer to a direct connection or coupling with the other component, or to a case where another component is interposed therebetween. Meanwhile, when a component is referred to as “directly connected to” or “directly coupled to” another component, it indicates that there is no other component interposed therebetween. The expression “and/or” is taken to include each of the mentioned items and any combination of one or more.

The terminology used in this specification is for the purpose of describing embodiments, and is not intended to limit the present disclosure. In this specification, the singular form includes the plural form unless otherwise specified in the phrase. The “comprises” and/or “comprising” used in the specification do not preclude the presence or addition of one or more other components, steps, operations, and/or devices mentioned.

Although the terms “first”, “second”, and the like are used for describing various components, these components are not confined by these terms. These terms are merely used for distinguishing one component from the other components.

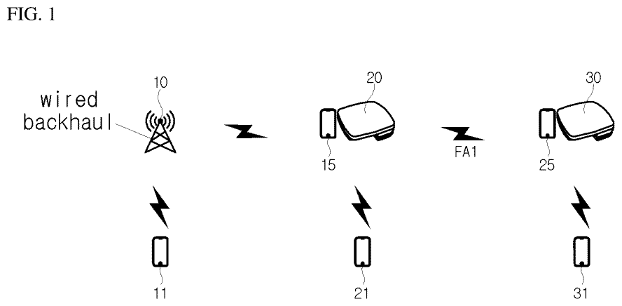

FIG. 1 is a diagram illustrating a small cell system configuration utilizing wireless backhaul according to the present invention.

With reference to FIG. 1, a type A base station is composed of a single 5G base station 20 and a backhaul terminal 15, where the 5G base station 20 may only perform access terminal services during the first 5 ms interval of each 10 ms frame (first half frame). The 5G base station 20 of type A does not transmit wirelessly during the second 5 ms interval (second half frame), thereby avoiding interference with the backhaul terminal 15. Consequently, the backhaul terminal 15 of type A may send and receive backhaul data during the second 5 ms interval of the 10 ms frame.

In a similar manner, the 5G base station 30 of type B may only perform access terminal services during the second 5 ms interval (second half frame) of each 10 ms frame, while the backhaul terminal 25 of type B may send and receive backhaul data during the first 5 ms interval (first half frame) of each 10 ms frame. By alternating between type A and type B base stations, multi-hop relay can be enabled wirelessly.

Finally, the type C base station is a 5G base station 10 with a wired backhaul, serving as the final end of the backhaul relay. Therefore, the type C base station may provide services not only to general access terminals but also to the backhaul terminal 15 of type A base station and the backhaul terminal 25 of type B base station.

As described above, a base station performing backhaul services through wireless relay must conduct access services only during predetermined intervals to avoid interference with the backhaul terminal, refraining from wireless transmission during the remaining intervals. To this end, this specification defines three types of operation for the 5G base station.

Type A: Operates to provide wireless communication services only during the first 5 ms of the 10 ms frame (or HF 0), and does not perform wireless transmission or reception during the second 5 ms (or HF 1).

Type B: Operates to provide wireless communication services only during the second half frame of each 10 ms frame and does not perform wireless transmission or reception during the first half frame.

Type C: Can provide wireless communication services to terminals throughout the entire 10 ms frame. The serviced terminals may be terminal 11, which directly accesses the base station, or backhaul terminals 15 and 25. Access terminal 11 may utilize the entire time interval, while backhaul terminals 15 and 25 may only operate as either type A or type B. That is, backhaul terminals 15 and 25 attempting to access during the first half frame may only use the resources of that half, while those attempting access during the second half frame may only use the resources of that half. When it is impossible to identify whether the accessing terminal is an access terminal or a backhaul terminal during the initial connection phase, the type C base station 10 may assume the accessing terminal is a backhaul terminal and may operate as either type A or type B.

During the initial access to receive wireless communication services, the backhaul terminals 15 and 25 of the base station transmit a random access preamble through the physical random access channel (PRACH). When connected to the base station through the PRACH in the first half frame, the backhaul terminal 15 or 25 may receive wireless communication services for backhaul data transmission using the first half frame. Consequently, the base station transmitting backhaul data through the backhaul terminal 15 or 25 must operate as type B, as communication may only occur during the second half frame to avoid collisions with the backhaul terminal. Similarly, when connected to the upper base station through the PRACH in the second half frame, the backhaul terminal 15 or 25 may receive wireless communication services for backhaul data transmission using the second half frame. In this case, the base station transmitting backhaul data through the corresponding backhaul terminal 15 or 25 must operate as type A, as communication may only occur during the first half frame to avoid collisions with the backhaul terminal.

The operations corresponding to each type of base station will be described below. For simplicity, a 5G base station with a subcarrier spacing of 30 kHz (=1) is assumed, resulting in a slot interval of 0.5 ms within the frame.

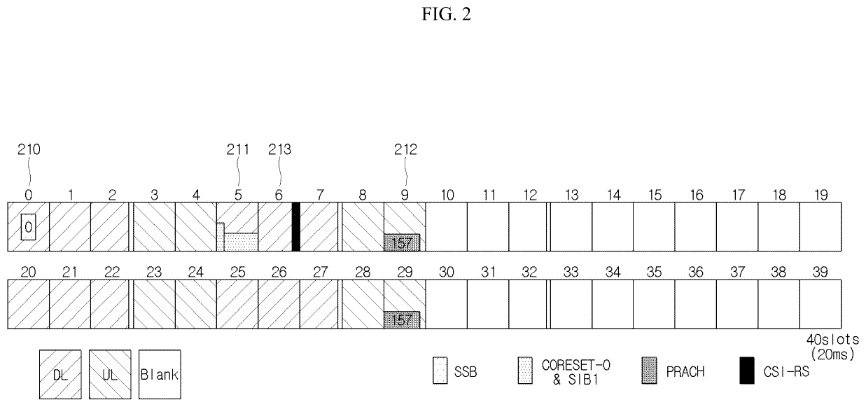

FIG. 2 is a diagram illustrating a frame structure used in type A base stations.

With reference to FIG. 2, a type A base station performs 5G communication services only during the first half frame (5 ms, 10 slots) of every 10 ms frame synchronized with global positioning system (GPS) and does not perform wireless transmission or reception during the second half frame (5 ms, 10 slots). However, tasks that do not trigger actual wireless transmission, such as statistical processing, may be carried out at any time.

As described above, the type A base station is in a scenario where the connected backhaul terminal accesses the upper base station through the allocated PRACH in the second half frame of the upper base station. Here, “upper” may refer to a base station that is closer to the 5G core system in the relay hierarchy. The upper base station may be a type C base station capable of providing 5G wireless communication services during both the first half frame and second half frame intervals, or a type B base station capable of providing 5G wireless communication services only during the second half frame interval.

With reference to FIG. 2, the type A base station employs a time division duplex (TDD) slot structure with a 10 ms interval, represented by the pattern ‘DDSUU DDSUU BBBBB BBBBB,’ which repeats every frame. Here, D represents a downlink slot used for data transmission from the base station to the terminal, U denotes an uplink slot used for data transmission from the terminal to the base station, S denotes a special slot that includes downlink, gap, and uplink periods, and B denotes a blank slot where no wireless resources are allocated for data transmission.

For the type A base station, since backhaul terminals perform wireless transmission and reception for backhaul data transfer during the second half frame, the radio frequency (RF) amplifier may be maintained in a completely off state to minimize interference. In the case of the type A base station, all wireless resources must be allocated to the first half frame, meaning that control channels, such as the System Synchronization Block (SSB), Control Resource Set 0 (CORESET-0), System Information Block 1 (SIB-1), Physical Random Access Channel (PRACH), and Channel Status Information Reference Signal (CSI-RS), must also be allocated to the first half frame.

In the example of FIG. 2, the SSB for the type A base station has a cycle of 20 ms (40 slots) and may be transmitted in the first slot 210 of the 20 ms period using SSB index 0. Similarly, CORESET-0 and the corresponding SIB1 are also transmitted every 20 ms and may be sent in the 6th slot 211 of each 20 ms period. PRACH is assigned to the 10th slot 212 every 10 ms, using a specific index (e.g., index 157), allowing terminals to initially access the type A base station through PRACH. CSI-RS may be allocated to the last symbol of the 7th slot 213 every 20 ms.

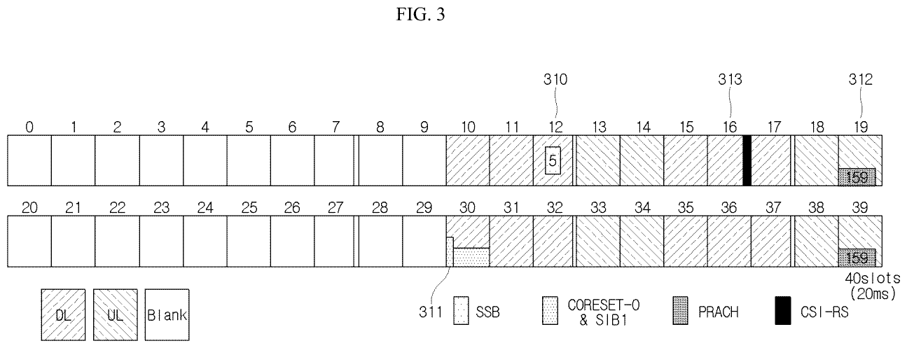

FIG. 3 is a diagram illustrating a frame structure used in type B base stations.

With reference to FIG. 3, the type B base station performs 5G communication services only during the second half frame interval of every 10 ms frame synchronized with GPS, and does not perform wireless transmission and reception during the first half frame interval. However, tasks that do not trigger actual wireless transmission, such as statistical processing, may be carried out at any time.

As described above, the type B base station is in a scenario where the connected backhaul terminal accesses the upper base station through the allocated PRACH in the first half frame of the upper base station. Here, “upper” may refer to a base station that is closer to the 5G core system in the relay hierarchy. The upper base station may be a type C base station capable of providing 5G wireless communication services during both the first half frame and second half frame intervals, or a type A base station capable of providing 5G wireless communication services only during the first half frame interval.

With reference to FIG. 3, the type B base station employs a TDD slot structure with a 10 ms interval, represented by the pattern ‘BBBBB BBBBB DDSUU DDSUU,’ which repeats every frame. Here, D represents a downlink slot used for data transmission from the base station to the terminal, U denotes an uplink slot used for data transmission from the terminal to the base station, S denotes a special slot that includes downlink, gap, and uplink periods, and B denotes a blank slot where no wireless resources are allocated for data transmission.

For the type B base station, since backhaul terminals perform wireless transmission and reception for backhaul data transfer during the first half frame, the RF amplifier may be maintained in a completely off state to minimize interference. In the case of the type B base station, all wireless resources must be allocated to the first half frame, meaning that control channels, such as the SSB, CORESET-0, SIB-1, PRACH, and CSI-RS, must also be allocated to the second half frame.

In the example of FIG. 3, the SSB for the type B base station has a cycle of 20 ms (40 slots) and may be transmitted in the 13th slot 310 of the 20 ms period using SSB index 5. Similarly, CORESET-0 and the corresponding SIB1 are transmitted every 20 ms and may be sent in the 31st slot 311 of each 20 ms period. PRACH is assigned to the 20th slot 312 every 10 ms using a specific index (e.g., index 159), allowing terminals to initially access the type B base station through PRACH. CSI-RS may be allocated to the last symbol of the 17th slot 313 every 20 ms.

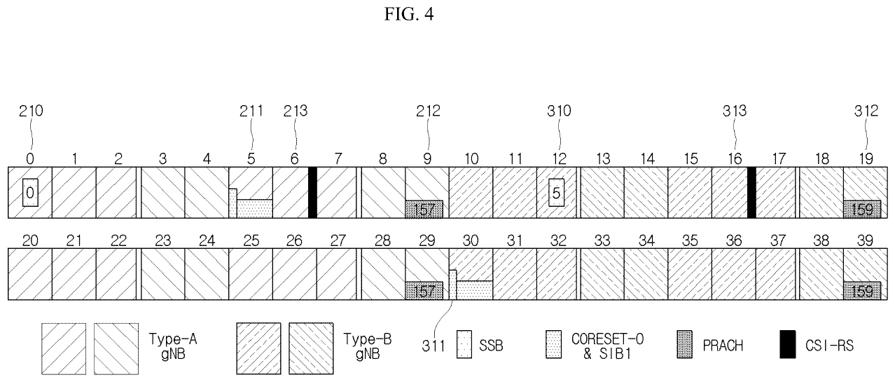

FIG. 4 is a diagram illustrating a frame structure used in type C base stations.

With reference to FIG. 4, the type C base station may provide 5G communication services throughout the entire 10 ms frame synchronized to GPS.

The type C base station may operate as the final node of the backhaul relay.

The type C base station may be accessed by direct access terminals, backhaul terminals from Type A base stations, and backhaul terminals from Type B base stations, and to service all these devices, the Type C base station may simultaneously operate as both type A and type B base stations. Logically, this is equivalent to two base stations operating independently at the same time. That is, while the type C base station may logically execute the operations of both type A and type B base stations separately, in practice, the programs for both may be serviced simultaneously within a single base station.

Since the type C base station may service both direct access terminals and backhaul terminals, it is necessary to distinguish whether a specific terminal is a backhaul terminal or not. The operation may differ depending on whether the connected terminal is a direct access terminal or a backhaul terminal. As an example, a backhaul terminal must be served using only the half-frame to which it is connected, while a direct access terminal may be served using any time slot within the entire frame. By doing so, maximum throughput may be achieved. In the embodiment of FIG. 4, the type C base station employs a TDD slot structure with 10 ms interval, represented by the pattern “DDSUU DDSUU DDSUU DDSUU.” In the case of the type C base station, there are no blank slots B where wireless resources are not allocated; only downlink slots D, uplink slots U, and special slots S exist.

According to an embodiment, the TDD slot structure of the type C base station illustrated in FIG. 4 may be identical to the TDD slot structure of the type A base station shown in FIG. 2 during the first half frame, and identical to the TDD slot structure of the type B base station shown in FIG. 3 during the second half frame.

As shown in FIG. 1, handover is essential for changing the base station that serves each terminal in a wireless communication system supported by wireless relay backhaul. To facilitate handover, all terminals may be configured for measurements for handover at any time interval. For example, even a terminal served only by the type A base station during the first half frame may also perform measurements during the second half frame for handover purposes.

However, in order to hand over a backhaul terminal to a different type of base station, it is necessary first to release all terminals connected to that base station, turn off the base station output, and then perform the handover. Additionally, when the transmission period of the base station overlaps with the period being measured by the backhaul terminal, it may be impossible to take measurements due to excessive interference. For these reasons, a backhaul terminal may be configured to perform handover only to base stations of the same type, preventing handover to different types of base stations.

By configuring the measurement timing for handover for each type of base station, as shown in Table 1 below, measurement using SSB can be facilitated.

TABLE 1

| | type A base station | type B base station |
|---|---|---|
| measurement configuration | 20 subframes | 20 subframes |
| periodicity | | |
| offset | 0 | 6 subframes |
| duration | 1 subframe | 1 subframe |

The type C base station may include both the two aforementioned measurement timing configurations.

For general terminals, since they can connect to any base station to transmit data regardless of type, it is possible to simultaneously support the measurement timing configuration for type A base stations and the measurement timing configuration for type B base stations, thus enabling handovers between type A and type B base stations. This also applies to type C base stations.

For example, with reference to FIGS. 2 to 4, a general terminal may perform measurements on the type A base station or type C base station during the first subframe (or first slot, slot 0) of the 20 subframes (40 slots) within a 20 ms interval, and may also perform measurements on the type B base station or type C base station during the seventh subframe or 13th slot (slot 12) of the same 20 subframes (40 slots), allowing it to request a handover between the type A base station, type B base station, and/or type C base station based on the measurement results.

A backhaul terminal may only be configured with a single setup that is identical to the type currently being serviced.

For a backhaul terminal, only one configuration can be set up that matches the type of the base station that the terminal is currently connected for transmitting backhaul data.

For example, a backhaul terminal for a type A base station may connect to either a type B or type C base station to transmit backhaul data. Therefore, the backhaul terminal for the type A base station may only configure the measurement timing setup for the type B base station as shown in Table 1. Consequently, the backhaul terminal for the type A base station may perform measurements on the type B base station or type C base station in the seventh subframe or the 13th slot (slot 12) within the 20 subframes (40 slots) of 20 ms, and based on the results, may request a handover between the type B and/or type C base stations.

The backhaul terminal for a type B base station may connect to either a type A or type C base station to transmit backhaul data. Thus, the backhaul terminal for the type B base station can only configure the measurement timing setup for the type A base station as shown in Table 1. Consequently, the backhaul terminal for the type B base station may perform measurements on the type A base station or type C base station in the first subframe or the first slot (slot 0) within the 20 subframes (40 slots) of 20 ms, and based on the results, may request a handover between the type A and/or type C base stations.

For measurement purposes, one or more measurement objects may be defined. The following are the key parameters that may be defined as measurement objects.
ssbFrequency: AFRCN for SSB
ssbSubcarrierSpacing: 30 KHz
smtc: SSB Measurement Timing Configuration
referenceSignalConfig: RS configuration for SSB and CIS-RS
“blacklisted” cells, “whitelisted” cells

The following are the key parameters defined in periodicReportConfig for period reporting.
rsType: Measurement target signal (SSB or CSI-RS)
reportInterval: reporting interval
reportQuantityCell: reporting information (RSRP/RSRQ/SINR)

The measurement identifier (Measurement identity) may be defined to associate a single measurement object with one or more measurement reporting configurations and may also associate one or more measurement objects with a single measurement reporting configuration.

The terminal may perform measurements on all SSBs within the SSB Measurement Timing Configuration (SMTC) window. Notably, SSB-MTC is defined as a list in the 3GPP standard document TS 38.331, and in the examples of this specification, SMTC is configured as follows to support handover between different types of base stations. The scan period is 20 ms, and the scan time is 1 ms.
measTiming[0]→type Abase station SSB (SSB index 0) scan
periodicityAndOffset: sf20=0
duration: nr-duration-sf1
measTiming[1]→type B base station SSB (SSB index 6) scan
periodicityAndOffset: sf20=6
duration: nr-duration-sf1

The base station, when transmitting SMTC information to a connected terminal, queries the 5GC to determine whether the terminal is a backhaul terminal, sending only measTiming[0] for connection via SSB-0 (Type A) or only measTiming[1] for connection via SSB-5 (Type B). The two sets of timing information defined above may only be transmitted in full to support handover between type A and type B base stations when the connected terminal is not a backhaul terminal.

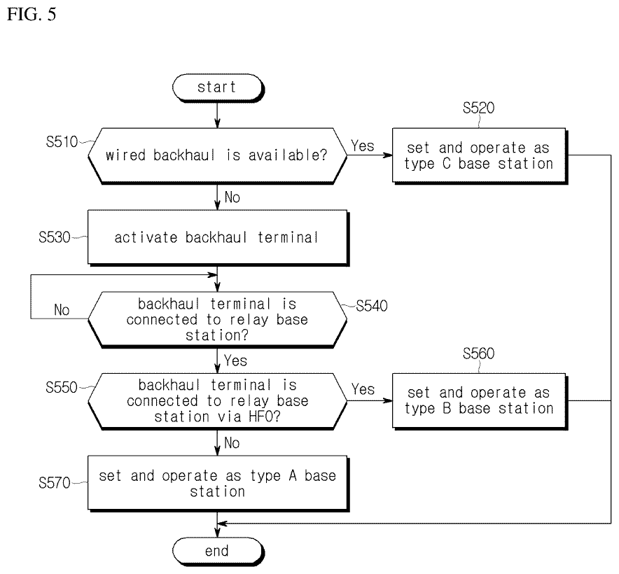

FIG. 5 is a flowchart illustrating a method for determining the type of base station.

FIG. 5 illustrates the method by which a base station determines its own type upon deployment.

With reference to FIG. 5, the base station may determine in operation S510 whether a wired backhaul connection is available. When it is determined that a wired backhaul connection is available, the base station may configure itself as a type C base station in operation S520.

Conversely, when it is determined that a wired backhaul connection is unavailable, the base station may activate the backhaul terminal in operation S530 to attempt a connection to the upper relay base station.

In operation S540, the base station may determine whether the backhaul terminal has successfully connected to the relay base station and may wait until the connection is established.

In operation S550, the base station determines whether the backhaul terminal has connected to the relay base station through the first half frame (HF0). When it is determined that the backhaul terminal is connected to the relay base station via the first half frame (HF0), the base station may configure itself as a type B base station in operation S560 to minimize interference with the wireless signals from the backhaul terminal. When it is determined that the backhaul terminal is connected to the relay base station through the second half frame (HF1), the base station may configure itself as a type A base station in operation S570 to reduce interference with the wireless signals from the backhaul terminal.

All base stations and terminals in the wireless backhaul system illustrated in FIG. 1 operate according to 3GPP standards. However, depending on its type, the base station may operate the scheduler (e.g., MAC scheduler) to allocate wireless resources only in half frames where the scheduler may assign wireless resources to the terminal.

As mentioned earlier, this specification proposes a method for providing wireless backhaul to base stations using the same frequencies that deliver wireless communication services.

In this case, general terminals may perform handovers among any base stations, while backhaul terminals may only perform handovers with base stations that support the same type as the currently connected base station, thereby ensuring continuous service for all terminals connected to the corresponding base station.

Although the above description is based on 5G wireless communication, the proposals in this specification may be extended to any mobile communication system where wireless backhaul is applicable.

The embodiments of the present invention are advantageous in terms of facilitating support of wireless backhaul at the base station by employing the same system for both wireless access and wireless backhaul on the same frequency band.

While the foregoing description has focused on particular embodiments of the invention, it should be understood that various modifications, combinations, and alterations may be made therein by those skilled in the art without departing from the spirit and scope of the invention as defined by the appended claims.

What is claimed is:

1. A wireless communication system providing communication services, the system comprising:
a type C base station comprising a wired backhaul and configured to provide communication service to general terminal and backhaul terminal using entire frame;
a type A base station configured to form a first wireless backhaul using a first backhaul terminal and provide communication service to general terminal and backhaul terminal using first half-frame of the frame; and
a type B base station configured to form a second wireless backhaul using a second backhaul terminal and provide communication service to general terminal and backhaul terminal using second half-frame of the frame,
wherein the type A base station forms the first wireless backhaul through the first backhaul terminal connected to the type C base station or the type B base station, and the type B base station forms the second wireless backhaul through the second backhaul terminal connected to the type C base station or the type A base station.

2. The wireless communication system of claim 1, wherein the type A base station transmits a wireless signal during the first half-frame of the frame to provide communication service, and the first backhaul terminal transmits a wireless signal carrying backhaul data during the second half-frame of the frame, minimizing interference between the wireless signals.

3. The wireless communication system of claim 1, wherein the type B base station transmits a wireless signal during the second half-frame of the frame to provide communication service, and the second backhaul terminal transmits a wireless signal carrying backhaul data during the first half-frame of the frame, minimizing interference between the wireless signals.

4. The wireless communication system of claim 1, wherein the first backhaul terminal is permitted to hand over to the type C base station or the type B base station, but not to the type A base station, and the second backhaul terminal is permitted to hand over to the type C base station or the type A base station, but not to the type B base station.

5. The wireless communication system of claim 1, wherein the general terminal is permitted to hand over to the type A base station, the type B base station, or the type C base station.

6. A base station system comprising:
a backhaul terminal; and
a base station,
wherein the base station is configured to:
set an operational type based on the availability of a wired backhaul connection;
provide, based on a wired backhaul connection being available, wireless communication service using entire frame for data transmission; and
activate, based on a wired backhaul connection being unavailable, the backhaul terminal and provide wireless communication service using either the first half-frame or the second half-frame of the frame, and
wherein the activated backhaul terminal is configured to transmit backhaul data of the base station using the second half-frame or the first half-frame not in use by the base station for wireless communication service.

7. The base station system of claim 6, wherein the base station is further configured to:
determine whether a wired backhaul connection is available;
set, based on the wired backhaul connection being available, the base station as a type C base station providing wireless communication services using both the first half-frame and the second half-frame;
set, based on the wired backhaul connection being unavailable, the base station as a type B base station providing wireless communication service using the second half-frame upon the backhaul terminal connecting to an upper base station using the first half-frame or set the base station as a type A base station providing wireless communication service using the first half-frame based on the backhaul terminal connecting to the upper base station using the second half-frame.

8. The base station system of claim 7, wherein, based on the base station being set as a type A base station, the backhaul terminal is configured to perform handover only to the type B base station or the type C base station based on measurements of the second half-frame of the type B base station or the type C base station.

9. The base station system of claim 7, wherein, based on the base station being set as a type B base station, the backhaul terminal is configured to perform handover only to the type A base station or the type C base station based on measurements of the first half-frame of the type A base station or the type C base station.

10. A method of operating a base station, the method comprising:
determining whether a wired backhaul connection is available;
setting and operating, based on a wired backhaul connection being available, as a type C base station providing wireless communication service using both first half-frame and second half-frame of a frame;
activating, based on the wired backhaul connection being unavailable, a backhaul terminal;
setting and operating, based on the backhaul terminal being connected to an upper base station using the first half-frame, as a type B base station providing wireless communication service using the second half-frame; and
setting and operating, based on the backhaul terminal being connected to the upper base station using the second half-frame, as a type A base station providing wireless communication services using the first half-frame.

11. The method of claim 10, wherein the setting and operating as the type A base station comprises:
providing wireless communication service to connected general terminals and backhaul terminals of other base stations using the first half-frame; and
transmitting backhaul data through the backhaul terminal during the second half-frame.

12. The method of claim 10, wherein the setting and operating as the type B base station comprises:
providing wireless communication service to connected general terminals and backhaul terminals of other base stations using the second half-frame; and
transmitting backhaul data through the backhaul terminal during the first half-frame.

13. The method of claim 10, wherein the setting and operating as the type A base station comprises allocating wireless resource for handover only during the first half-frame, and the setting and operating as the type B base station comprises allocating wireless resource for handover only during the second half-frame.
